(19) United States
(12) Patent Application Publication
(10) Pub. No.: US 2003/0061305 A1
(43) Pub. Date: Mar. 27, 2003

(54) System and method for enhancing streaming media delivery and reporting

(75) Inventors: Devon Copley, New York, NY (US); Elango Chidambaram, Jersey City, NJ (US); Chris Sokol, Weehawken, NJ (US); Alexander Henderson, Stroud (GB)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Chyron Corporation, Melville, NY

(21) Appl. No.: 10/107,228

(22) Filed: Mar. 26, 2002

Related U.S. Application Data
(60) Provisional application No. 60/280,702, filed on Mar. 30, 2001.

(51) Int. Cl. G06F 15/16

(52) U.S. Cl. 709/217; 709/231

(57) ABSTRACT

A content distribution system provides the ability for a user to select content from one location and, if problems develop in streaming the content to the user, to automatically fallback to a second location for the content. In particular, the system comprises a client-side computer, a management server, a reporting server, and an asset server. The client-side computer comprises a player for playing content to a user. The player initially selects a provider for providing the content as a function of previous service data associated with the provider, via the management server. If problems are encountered with providing the content from the selected provider, the player dynamically falls back to another provider of the content.

### CROSS REFERENCE TO RELATED APPLICATIONS

The present application claims the benefit of U.S. Provisional Application No. 60/280,702, filed Mar. 30, 2001, the disclosure of which is hereby incorporated by reference herein.

### BACKGROUND OF THE INVENTION

The invention relates generally to systems and methods for delivering streaming media and more particularly to systems and methods for enhancing streaming media delivery and reporting in a content distribution network (CDN).

Current streaming media delivery systems and methods are unreliable due in part to distribution network failures, varying delivery quality standards, and multiple media format standards. Distribution networks such as the Internet often fail to maintain adequate connections between media delivery servers and end user computers, causing media delivery sessions to end prior to completion, or to experience undesirable delays during delivery. Varying quality standards for delivery reduce reliability of media delivery across different systems. The popularity of multiple media format standards causes duplication of effort in the deployment of media selections, increases development costs, complicates media asset hosting and management arrangements, and makes unified reporting difficult.

In addition, current streaming media delivery systems and methods are unable to provide extensive and accurate real-time and historical reporting of media delivery demand and performance. Nor are they able to provide conditional delivery of media content, for example, for advertising purposes, on the basis of user or player preferences, demographics, or other relevant information. Nor are they adapted to integrate with media asset management systems to ease publishing.

### SUMMARY OF THE INVENTION

In accordance with the invention, a content distribution system provides the ability for a user to select content from one location and, if problems develop in streaming the content to the user, to automatically fallback to a second location for the content.

In accordance with an embodiment of the invention, a system comprises a client-side computer, a management server, a reporting server, and an asset server. The client-side computer comprises a player for playing content to a user. The player initially selects a provider for providing the content as a function of previous service data associated with the provider, via the management server. If problems are encountered with providing the content from the selected provider, the player dynamically falls back to another provider of the content.

### BRIEF DESCRIPTION OF THE DRAWINGS

FIG. 1 shows an illustrative block diagram of a system in accordance with the principles of the invention;

FIG. 2 shows an illustrative flow chart, in accordance with the principles of the invention, for use in the system of FIG. 1;

FIG. 3 shows another illustrative block diagram of a system in accordance with the principles of the invention;

FIG. 4 shows an illustrative structure for a media group and mediaballs;

FIG. 5 shows another illustrative flow chart in accordance with the principles of the invention; and

FIG. 6 shows an illustrative report for use in the system of FIG. 3.

### DETAILED DESCRIPTION

As described further below, the invention overcomes the above-described limitations by providing an end-to-end solution for the deployment of live and archived streaming media assets. It provides a high quality of service, extensive and accurate real-time and historical reporting, low development costs, and rapid time to market for both turnkey and customized media delivery solutions.

The inventive concept provides a high quality of service by using the streaming media deployment networks of a plurality of streaming media providers. (As used herein, a provider hosts content.) By leveraging the strengths of a number of providers, the invention achieves better performance than any single provider could achieve.

In addition, the inventive concept further provides for a high quality of service by using an intelligent network selection process to determine the optimum streaming media provider, and rank the remaining available providers, for each client. The intelligent network selection process involves collecting usage and performance data relevant to each provider, storing the data, and using the data to rank the providers.

The inventive concept further provides a high quality of service by employing client-side performance monitoring to automatically detect and correct connection failures or performance problems. When such difficulties are encountered, a system in accordance with the invention automatically switches the streaming activity to the next optimum provider to minimize disruption to the media delivery.

The inventive concept provides for extensive and accurate real-time and historical reporting by employing client-side collection of performance and user activity data. The collection of the data enables and provides unified reporting across multiple streaming media providers and for multiple media formats.

The inventive concept provides low development costs and rapid time to market by providing a media player that can accommodate a plurality of different media formats, including future formats. In addition, the inventive concept further provides for low development costs and rapid time to market by providing media asset management and distribution systems that make it easier for customers, or distributors, to transfer and publish content.

Thus, a system in accordance with the principles of the invention enables a user to experience a media selection authored by others (e.g., any entity that authors one or more media selections that are published so that the media selections can be experienced by the user). (As used herein, a media selection comprises audio selections and/or video selections and are also referred to as “content”.)

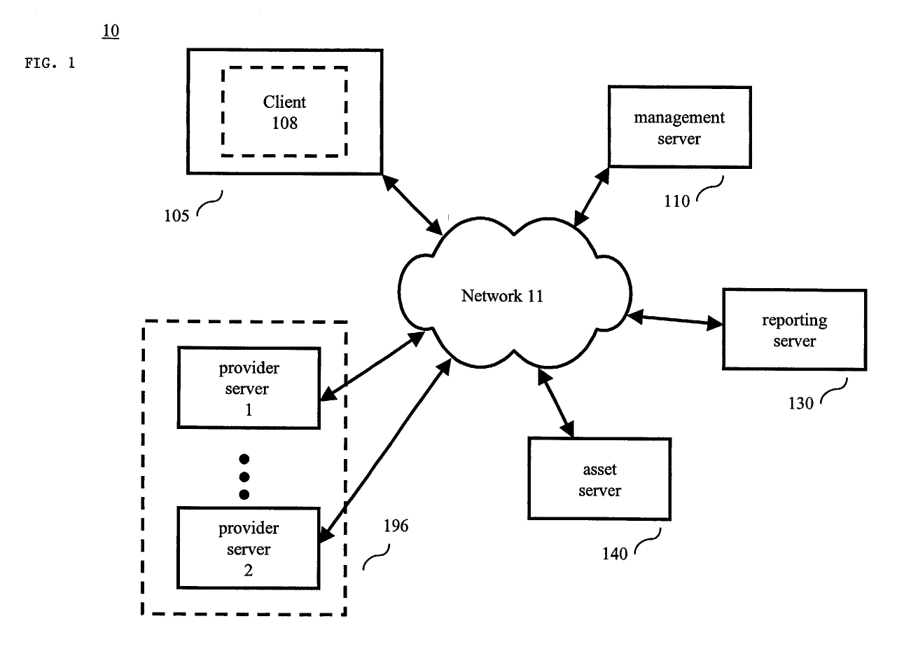

An illustrative system 10 in accordance with the principles of the invention is shown in FIG. 1. Other than the inventive concept, the elements shown in FIG. 1 are well known and not described further herein. For example, a server (e.g., management server 110) is typically a high-performance, multi-processor based computer system as known in the art. In addition, elements of the inventive concept are implemented using conventional programming techniques (including, e.g., HTML, etc.), which, as such, will not be described herein. As described further below, system 10 is a combination of server side and client side technologies designed to enhance the reliability of streaming media (e.g., Real Media, Windows Media, MPEG, Quicktime, DIVX, etc.).

System 10 of FIG. 1 comprises a distributed network comprising at least one client (user, or end-user) computer-based platform 105 (client-side 105), and a plurality of other servers—e.g., provider 1, provider 2, media management (management) server 110, reporting server 130 and asset server 140 (all described further below). It is assumed that the various elements shown in FIG. 1 are coupled together via a network 11. For the purposes of this description it is assumed that network 11 is representative of the Internet, although the inventive concept is not so limited and may apply, e.g., to internal networks, etc. In this context, the various elements of system 10 communicate with one another through common communication protocols including transmission control protocol/Internet protocol (TCP/IP) and hypertext transfer protocol (HTTP).

Client-side 105 comprises for example, a personal computer with all of the components normally found in a personal computer, running an operating system upon which software applications can run, including networking software and a Web browser for visiting Web sites, viewing Web pages, running Web applications and transferring files. In accordance with the invention, one of the software applications is client 108 (described below).

Each server of FIG. 1 comprises, for example, a server computer with all of the components normally found in a server computer, running a server operating system upon which software applications can run, including networking software and server software for serving Web pages, Web applications, and files, and soliciting and receiving data from the user client and other servers.

For the purposes of this example, it is assumed that a number of host providers 196 (also referred to herein as simply “providers”, or “media delivery servers”), exist for providing content, as represented by provider server 1 and provider server 2 of FIG. 1. Provider server 1 hosts a first media file (not shown in FIG. 1) (e.g., at a first location), while provider server 2 hosts a second media file (not shown in FIG. 1) at a second location.

Illustratively, each of the first and second media files represent the same type of media selection (e.g., the same video clip of a recent news event) and both are capable of being played by client 108. As will be discussed below, and in accordance with the invention, the second media file serves as a backup file if the streaming of the first media file fails. In this regard, and in accordance with the invention, client 108 is adapted to play the first media file from the first location, and, when the streaming of the first media file fails, to detect the failure and play the second media file from the second location (described below). It should be understood that each provider server is adapted to stream its media file to the player on demand in a manner known in the art.

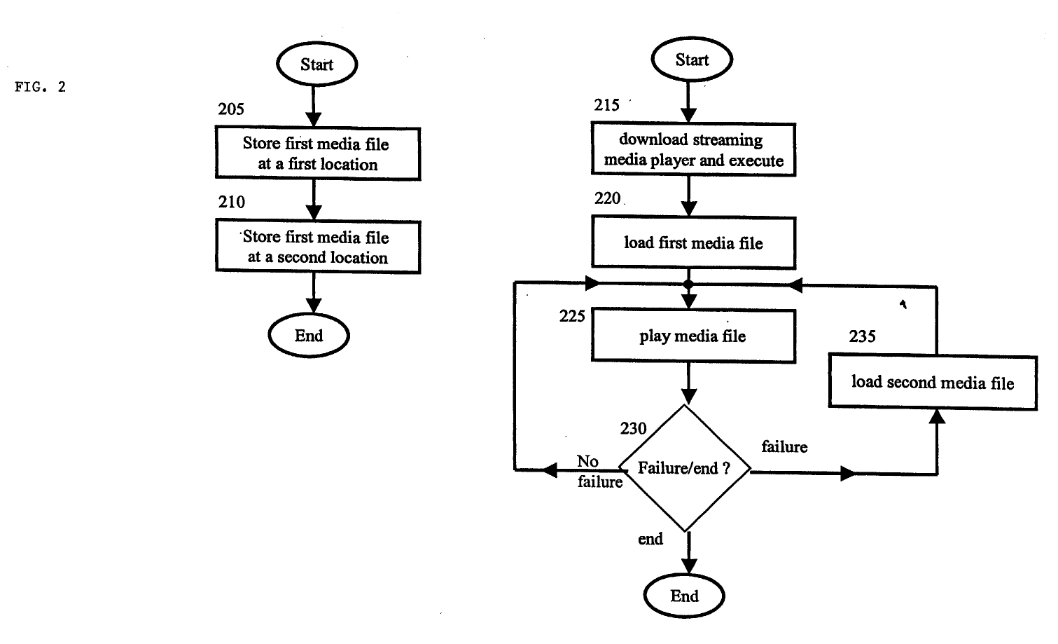

An illustrative flow chart of a method for use in accordance with the principles of the invention is shown in FIG. 2. It should be understood that the method of the invention can be practiced without regard to the specific system that is used to practice the invention. The flow chart of FIG. 2 provides a method for enabling a user to experience a media selection. In step 205, a first media file is stored at a first location. In step 210, a second media file is stored at a second location. Steps 205 and 210 are illustratively performed on the server-side of, e.g., system 10 of FIG. 1 by, e.g., management server 110 and/or provider servers 1 and 2. In step 215, client-side 105 downloads and executes a streaming media player for execution. (It should be noted that although the inventive concept is illustrated in the simple context of two media files (a first and a second), it is applicable to N media files, N>1.)

For example, a user associated with client-side 105, via a browser, accesses a link (not shown) displayed on a page provided by another server (not shown) (e.g., a distributor of the inventive concept). This link fetches a page (also from the distributor's server), and renders it in a popup browser window on client-side 105. This new page includes (via the SRC attribute of SCRIPT tags) at least the client 108 (comprising the streaming media player) (described below) codebase and a call to management server 110, which sets Javascript variables with all the data that client 108 requires.

This streaming media player begins execution in step 220 and loads, or retrieves, the first media file, which is played in step 225. (Preferably, prior to the streaming of the first file, the first location has been determined to be more optimum for streaming than the second location.) In step 230, the streaming media player checks for a failure condition or an end condition (e.g., end-of-file). If no failure condition occurs, the first media file continues to play. However, if a predefined failure condition is detected (e.g., disconnect), then the streaming media player loads, or retrieves, the second media file in step 235 and plays this media file in step 225. Regardless, upon detection of a predefined end condition (e.g., end-of-file), playing terminates. Thus, as described above, automatic fallback occurs to a second media file upon detection of a failure in playing the first media file.

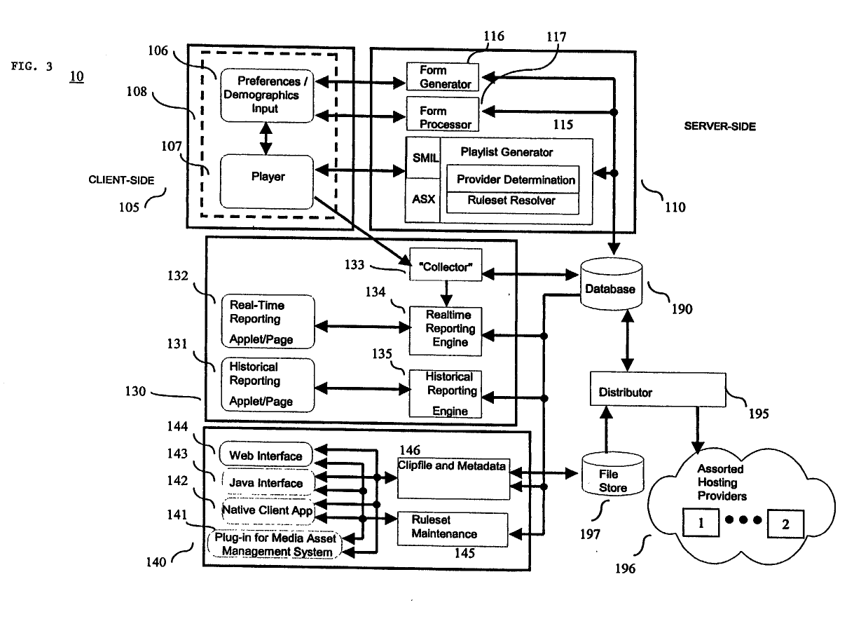

Turning now to FIG. 3 a more detailed block diagram of system 10 is shown. Client 108 further comprises a streaming media player 107 (player 107) and preference/demographics/input component 106 (input 106). Player 107 comprises, e.g., a Windows Media Player component and/or a Real Player component, as known in the art. Input 106 is for displaying a screen for collecting preference and/or demographic information from the user (described below).

Management server 110 is a server-side system that supplies client 108 with data to locate content to play. Management server 110 further comprises a playlist generator 115, which comprises a provider determination element, a ruleset resolver element, and SMIL/ASX elements (described below). In addition management sever 110 comprises form generator 116 and form processor 117 (described below).

Further in this aspect, client 108 is adapted to send a request to playlist generator 115, of management server 110, for a first media play list and to receive this first playlist from playlist generator 115. (A playlist is a SMIL or ASX file, which comprises one or more URLs (uniform resource locaters) associated with media clips.) Correspondingly, playlist generator 115 is adapted to receive the request from client 108, generate the playlist, and provide the playlist to client 108. Illustratively, the above-described requests are achieved via client 108 by entering a network address of playlist generator 115 (e.g., an associated URL). Client 108 is further adapted to use the first playlist to determine the first location (here, of provider server 1) and play the first media file therefrom. Preferably, as described below, provider server 1 has associated therewith a URL address that client 108 uses to access, and play, the first media file.

As mentioned above, client 108 may encounter connection failures and/or performance problems (all of which are to be understood as failures in that the streaming experience is disrupted or undesirable) when playing the first media file. In this event, and in accordance with the invention, client 108 automatically switches the streaming activity to another provider to minimize disruption to the media delivery. The types of failures encountered by client 108 can comprise any type of failure (e.g., a disconnect, etc.). Accordingly, client 108 is adapted to, when the streaming of the first media file fails, to send a request to playlist generator 115 for a second media playlist, receive the second playlist from playlist generator 115, use the second playlist to determine a second location (here, represented by provider server 2) and play the second media file from the second location. Preferably, provider server 2 has associated therewith a URL address that client 108 uses to access the second media file and play the second media file. Thus, in this particular embodiment of the invention, fallback to the second file is accomplished by retrieving the second playlist.

In another aspect of the invention, playlist generator 115 receives an indication of the failure of the streaming of the first file prior to providing the second playlist. Illustratively, client 108 provides, in the request for the second playlist, an indication of the failure and the associated provider. Preferably, the first playlist references the first file location and the second file location, and the second playlist references the second file location but not the first file location. Therefore in such embodiments, client 108 cannot use the second list to determine the first file location.

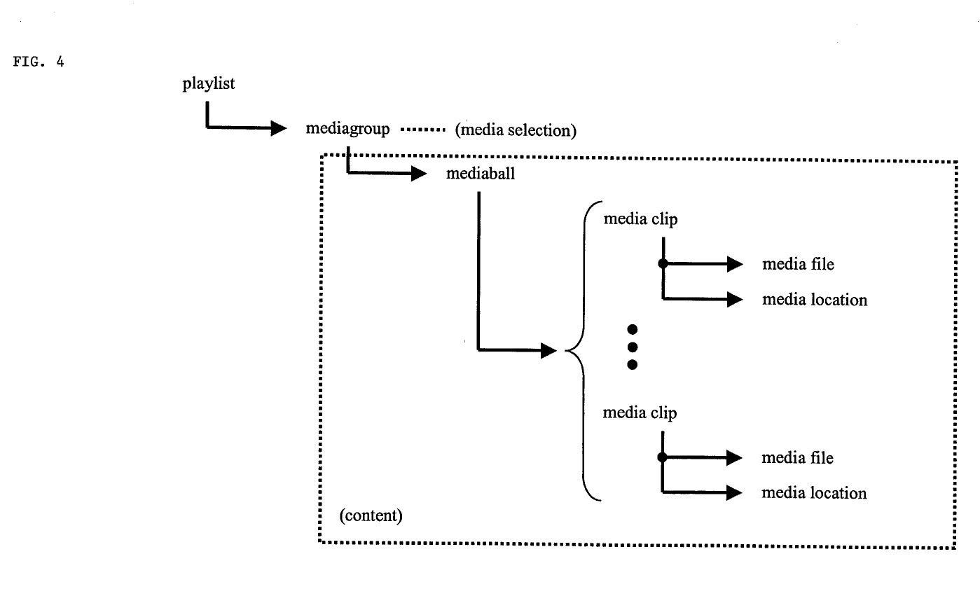

In another aspect of the invention, each play list generated by the playlist generator 115 references at least one media group. In accordance with the invention, each media group comprises a “mediaball.” In particular, each media group represents a media selection associated with the media group. A media selection comprises “content.” Further, each media group references at least one media clip, which represents a “media file”, in a particular format, e.g., a single Real Media or Windows Media file (note, other formats may also be used, e.g., MPEG, Quicktime, DIVX, etc.). As such, each such media clip represents the group-associated media selection in a particular format. Further, each such media clip references at least one media file that is in the clip-associated format and that presents the group-associated media selection when played. Further, each such media clip references, for each media file referenced by the media clip, a media file location from which the media file can be accessed. (As such, a clip file is simply a specific media file from a specific provider.) As discussed above, each media file location can be on one of the plurality media delivery servers (provider servers). Thus, a media ball is a collection of clips which represent the same content, possibly in multiple formats, bit rates, display sizes, etc. The above-described structure for a mediagroup and mediaballs is shown in FIG. 4.

Accordingly, each provider discussed above is referenced by a media clip referenced by a media group that represents the media selection that is presented when the associated files are played.

Client 108 accommodates one, or more, of the formats specified in one or more clips of each media group (e.g., Windows Media, or Real Media, etc.). In this manner, as noted above, the invention provides a media player that can accommodate a plurality of different media formats.

In yet another aspect of the invention, to assist the playlist generator 115 in the generation of the playlist, management server 110 comprises selection criteria and information, which describes each media selection associated with each group, each format associated with each clip, and each media file location.

The information comprises data associated with the media groups, media clips, and media file locations. Each media group has associated therewith a group metadata set describing the media selection associated with the group. Similarly, each media clip has associated therewith a clip metadata set describing the format associated with the clip. Further, each media file location has associated therewith a media file location address. Accordingly, the information in this aspect comprises each group metadata set, each clip metadata set, and each media file location address.

Each group metadata set comprises at least one of a value identifying a title of the media selection, a value identifying a publisher of the media selection, and a value identifying content of the media selection. Similarly, each clip metadata set comprises at least one of a value identifying a media file format, a value identifying a media file color depth, a value identifying a media file display size, a value identifying a media file bit rate, and a value identifying a media file resolution. In addition, each media file location address comprises a URL address.

The selection criteria comprises criteria established by, e.g., content providers, the user, etc. In addition, as described below, the selection criteria comprises player performance data. Playlist generator 115, in response to each playlist request, evaluates the information against the criteria to generate a respective playlist.

In particular, the selection criteria, comprises at least one of a ruleset, player preference data and user demographic data. Each ruleset comprises at least one rule. A rule is a set of filter expressions, which may, or may not, cause a specific mediaball to be included in a playlist. As an example, a rule can be that if a particular user indicates in provided demographic data that he or she is younger than 25 years old, the media play list shall include a media group that references a media selection that is an advertisement prepared for presentation to persons under the age of 25. As another example, a rule can be if the time is before 1:00 EST on a given day, the media play list shall include a media group that references a media selection that is a promotion for an upcoming live broadcast; but if the time is between 1:00 EST and 3:00 EST on that day, the media play list shall include a media group that references a media selection that is the live feed for the live broadcast; and if the time is after 3:00 EST on that day, the media play list shall include a media group that references a media selection that is an archived copy of the live broadcast. Thus, a ruleset is a number of rules collected together and evaluated en masse to produce a playlist. This is the basic data type provided to the player for playback of any content. The rules and rule sets comprises one, or more, of the rules and/or rule sets described under the heading “Rule/Ruleset Specification,” described below. It should be understood that the rules and/or rules set can be combined and/or nested as desired.

In still another aspect of the invention, the ruleset is provided by a customer of system 10, e.g., another user, or distributor. Accordingly, in this aspect, the system further comprises, as part of the distributed network, a customer client. The customer client can comprise, for example, a personal computer with all of the components normally found in a personal computer, running an operating system upon which software applications can run, including networking software and a Web browser for visiting Web sites, viewing Web pages, running Web applications, and transferring files via the network.

Further in this aspect, system 10 comprises a media asset manager server (asset server) 140 adapted to solicit and receive the rule set from the customer client and store the rule set in a storage medium in a manner associated with the customer. Asset server 140 is a collection of systems that the customer uses to do asset management. Using a web-based front end, asset server 140 manages the upload of content and distribution across the multiple provider networks. (It should be noted that such a management function could be integrated with other forms of management-type systems already available from third party vendors.) Asset manager 140 comprises the elements shown in FIG. 3 and includes web interface 144, Java interface 143, native client app 142, plug-in for media asset management system 141 (e.g., for use in a browser), ruleset maintenance element 145 and Clipfile and Metadata element 146. It should be observed that although shown as separate elements, asset server 140 can be a part of server 110. The solicitation and receipt of the rule set from the customer client is accomplished as described below. The storage of the rule set in a manner associated with the customer can be accomplished by registering each customer and providing a customer record and customer identifier for each customer, that can be used to access the customer's rule set or rule sets.

Preferably in this aspect, asset server 140 is adapted to associate a rule set identifier with the rule set. Also in this regard, playlist generator 115 selects the rule set during the evaluation (of the information against the selection criteria) using the rule set identifier. Further in this regard, the rule set identifier is stored on a hypertext markup language (HTML) page authored by the customer.

In still another aspect of the invention, the player preference data and the user demographic data are provided by the user client. Accordingly, in this aspect, management server 110 comprises a registrar adapted to solicit and receive, from client 108, and store in a storage medium (e.g., database 190) in a manner associated with the user, at least one of the player preference data and the user demographic data. The registrar comprises form generator 116 and form processor 117 (also described further below). The solicitation and receipt of the data from client 108 can be accomplished as described below. The storage of the data in a manner associated with the user can be accomplished, for example, by the registrar being adapted to associate a user identifier with the stored data. To further ensure that the data is stored so as to be associated with the user, the storage medium can comprise a cookie on a hard drive of client-side 105.

Further in this aspect, the preference data comprises at least one of a connection speed, a media player type, and a media file format. The demographic data comprises at least one of contact information, biological information, and interest information. For example, the demographic data comprises the demographic data discussed under the heading “Demographics Reference.” The preference data and the demographic data can be used by the playlist generator 115 to generate the playlist.

As noted above, the invention employs client-side performance monitoring to automatically detect and correct connection failures or performance problems. Also as noted above, the invention also provides extensive and accurate real-time and historical reporting by employing client-side collection of performance and user activity data. The collection of the data enables system 10 to provide unified reporting across multiple streaming media providers and for multiple media formats.

Accordingly, in still another aspect of the invention, the management server comprises a performance data reporting server (reporting server) 130. Client 108 is adapted to report to reporting server 130 performance data describing at least one performance aspect of client 108, and reporting server 130 is adapted to receive the performance data. Reporting server 130 is a server-side system, which collects information about executing client 108 sessions and provides reporting capabilities. Reporting server 130 comprises real-time reporting applet 132, historical reporting applet 131, collector 133, and a reporting engine, comprising real-time reporting engine 134 and historical reporting engine 135. Preferably in this aspect, the performance data comprises at least one of session start time, session end time, failure information, latency information, clip viewed information, and transport activity.

The reporting engine of reporting server 130 is adapted to receive the performance data, process the performance data for real-time, or historical, reporting, and provide the processed performance data to a respective report viewer (e.g., applet 132). Real-time report viewer 132 is adapted to request and receive the processed performance data from the reporting application. Therefore, by using the real-time report viewer 132, performance data during the media delivery can be reviewed by, e.g., customers, distributors, etc.

When providing a historical reporting feature, the reporting engine of reporting server 130 is adapted to store the performance data in a storage medium so that the performance data can be retrieved (e.g., database 190), analyzed for historical trends and provide the processed performance data to a historical report viewer 131 for viewing by, e.g., a customer. Therefore, by using the historical report viewer, the customer can review the historical reports for trends and other information.

In another aspect of the invention, prior to the streaming of the first file, it is assumed that provider server 1 has been determined to be more optimum to the user than provider server 2. This determination can be made, for example, using the above-mentioned selection criteria. As noted above, the selection criteria comprises, e.g., a rule set, player preference data, user demographic data, and player performance data. The selection criteria can be used to rank providers, for example, according to how well they are anticipated to deliver requested media files to the client 108 through the streaming process. The various ways in which this ranking can be accomplished is described further below.

In still another aspect of the invention, system 10 further comprises asset server 140. A customer client (not shown) is adapted to transfer to asset server 140, and asset server 140 is adapted to receive from the customer client, the following items: (1) at least one media group; (2) each media clip referenced by each media group; (3) each media file referenced by each media clip; (4) a group metadata set for each media group, describing the media selection associated with the group; and (5) a clip metadata set for each media clip, describing the format associated with the clip.

Thus, prior to the streaming of the first media file, the first and second media files in this aspect are accordingly transferred from the customer client to the asset manager.

So that the media selections can be published for presentation to the user, system 10 comprises a media distributor 195 adapted to receive a request to schedule at least one media selection for publication. Media distributor 195 is further adapted to, for each media selection to be published, publish the media selection in accordance with the scheduling request by transferring, to a respective location on one of the plurality of media delivery servers (e.g., provider server 1 or provider server 2), each media file referenced by each media clip referenced by the media group representing the media selection. For live media events, the media file is being transferred as it is being streamed. For non-live media events, the media file is transferred in full before it is streamed. (It should be noted that media distributor 195 is not required for the inventive concept.)

So that the transferred media files can be located by client 108, media distributor 195 is further adapted to, for each transferred media file, store a media file location address, that can be used to access the media file, in a storage medium in a manner associated with the media clip referencing the media file. As described below, the media file location addresses are preferably URL addresses.

Thus, provider server 1 and provider server 2 are illustratively two of the plurality of media delivery servers.

It should be noted that in this aspect, especially when managing non-live media events, asset server 140 can be adapted to store each transferred media group, media clip, media file, group metadata set, and clip metadata set in a storage medium (e.g., element 146). The storage medium can comprise the “file store” described below.

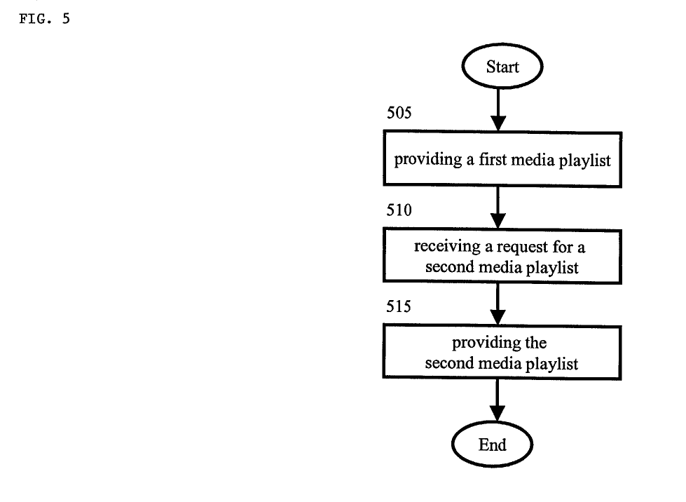

In one aspect of the method of the invention, the method comprises receiving a request from the player for a first media play list, generating the first list, the first list identifying the first location; providing the first list to the player; and when the streaming of the first file fails: receiving a request from the player for a second media play list; generating the second list, the second list identifying the second location; and providing the second list to the player. A representative flow chart is shown in steps 505 to 515 of FIG. 5 for use in, e.g., management server 110.

In another aspect of the method of the invention, the method comprises, prior to generating the second list, receiving an indication of the failure. Preferably, the first list references the first file location and the second file location, and the second list references the second file location but not the first file location.

In another aspect of the method of the invention, each generated media play list references at least one media group, each media group representing a media selection associated with the media group; each media group references at least one media clip, each media clip representing the group-associated media selection in a format associated with the media clip; each media clip references at least one media file that is in the clip-associated format and that presents the group-associated media selection when played; each media clip references, for each media file referenced by the media clip, a media file location from which the media file can be accessed; and the first and second file locations are referenced by a media clip referenced by a media group that represents the media selection. Preferably, the player can accommodate each format associated with each clip.

In another aspect of the method of the invention, generating a respective play list comprises retrieving information describing each media selection associated with each group, each format associated with each clip, and each media file location; retrieving selection criteria; and evaluating the information against the criteria to generate the respective play list. Preferably, each media group has associated therewith a group metadata set describing the media selection associated with the group; each media clip has associated therewith a clip metadata set describing the format associated with the clip; each media file location has associated therewith a media file location address; and the information comprises each group metadata set, each clip metadata set, and each media file location address. Also preferably, each group metadata set comprises at least one of a value identifying a title of the media selection, a value identifying a publisher of the media selection, and a value identifying content of the media selection. Also preferably, each clip metadata set comprises at least one of a value identifying a media file format, a value identifying a media file color depth, a value identifying a media file display size, a value identifying a media file bit rate, and a value identifying a media file resolution. Also preferably, each media file location address comprises a uniform resource locator address.

In another aspect of the invention, the method comprises collecting from the player performance data describing at least one performance aspect of the player, wherein the selection criteria comprises the performance data. The selection criteria can alternatively or additionally comprise at least one of a rule set, player preference data, user demographic data.

In another aspect of the invention, the method comprises soliciting and receiving a rule set from a customer and storing the rule set in a storage medium in a manner associated with the customer. Preferably, the method further comprises associating a rule set identifier with the rule set. Also preferably, the method further comprises selecting the rule set during the evaluation using the identifier.

In another aspect of the invention, the method comprises soliciting and receiving from the user, and storing in a storage medium in a manner associated with the user, at least one of the player preference data and the user demographic data. Preferably, the method further comprises associating a user identifier with the stored data. Also preferably, the storage medium is a cookie on a hard drive of a user client. Also preferably, the preference data comprises at least one of a connection speed, a media player type, and a media file format. Also preferably, the demographic data comprises at least one of contact information, biological information, and interest information.

In another aspect of the invention, the method comprises collecting from the player performance data describing at least one performance aspect of the player. Preferably, the performance data comprises at least one of session start time, session end time, failure information, latency information, clip viewed information, and transport activity. Also preferably, the method further comprises processing the performance data for real-time reporting and provide the processed performance data to a real-time report viewer adapted to request and receive the processed performance data. Also preferably, the method further comprises storing the performance data in a storage medium. Also preferably, the method further comprises processing the performance data for historical reporting and providing the processed performance data to a historical report viewer adapted to request and receive the processed performance data.

In another aspect of the invention, the method comprises receiving from a customer: (1) at least one media group, each media group representing a media selection associated with the media group, each media group referencing at least one media clip, each media clip representing the group-associated media selection in a format associated with the media clip, each media clip referencing at least one media file that is in the clip-associated format and that presents the media selection when played; (2) each media clip referenced by each media group; (3) each media file referenced by each media clip; (4) a group metadata set for each media group, describing the media selection associated with the group; and (5) a clip metadata set for each media clip, describing the format associated with the clip. Accordingly, prior to the streaming of the first media file, the first and second media files were received from the customer.

In another aspect of the invention, the method comprises receiving a request to schedule at least one media selection for publication; for each media selection to be published, publishing the media selection in accordance with the scheduling request by transferring, to a respective location on one of the plurality of media delivery servers, each media file referenced by each media clip referenced by the media group representing the media selection; and for each transferred media file, storing a media file location address, that can be used to access the media file, in a storage medium in a manner associated with the media clip referencing the media file. Preferably, the method further comprises storing each transferred media group, media clip, media file, group metadata set, and clip metadata set in a storage medium.

Although not necessary for an understanding of the inventive concept, for those readers that are interested, the remainder of the detailed description provides additional illustrative details for implementation for various elements of FIG. 3.

Client 108

Upon execution, client 108 first checks if the user has filled in preferences/demographic data (re: input 106). If this information has never been filled out, the user is redirected to a form (served by management server 110, via elements 116 and 117), which asks about preferences (preferred streaming client, bandwidth, etc.) as well as demographic data (these questions are defined by the distributor). The form is submitted back to management server 110, which updates database 110 and redirects back to the original page. This is an HTML form (which includes Javascript to enforce constraints such as required fields or Combo field rules) and lets the user specify their playback preferences, as well as answer an arbitrary number of Customer defined questions. Each demographic question has a data type, which can be String (a free form user type-in field), Lookup (a multiple-choice drop down field), Integer (a numeric type-in field), Boolean (a checkbox), or Combo (a Lookup type combined with a String type —one of the Lookup choices will be “Other”, which, when chosen, allows the user to type in free form text). Demographic questions can be either optional or required; if required, the user will have to answer them before being allowed to view the requested content.

When the user submits the form, it is processed by the form processor 117 of management server 110. All user responses are recorded in the database, and a cookie is set with playback preferences information.

Both client 108 and management server 110 have to agree on the file format for the clip(s) to be played to the user—the user's preferred player component will be used if all clips are available in that format (e.g., Real Player), but if not, then an alternate player will be used assuming A) that that player component is installed on the user's system (this can be determined user, e.g., sniff detection), and B) all clips are available in that alternate format.

Client 108 then builds a user interface, including the selected player component (player 107), and tells the player component to play from the highest priority server. If playback can not start, or fails while playing, then client 108 switches to a lower priority server.

During playback of video, client 108 constantly reports player status back to management server 110, this status including, but not limited to, information about failures, latency, and other information, which can be used to reprioritize servers or repair problems.

The main purposes of client 108 are to provide a common API for dealing with different media players, and to enhance reliability by performing fallback to backup servers. It also returns reporting messages back to the reporting server, providing performance and usage data. Client 108 provides the client-side intelligence to support the failure recovery and reporting capabilities of the system 10. It also provides a player control API (application programming interface), preferably implemented in Javascript, which abstracts away the differences between the Windows Media and Real Player embedded player, thus simplifying custom player development.

Client 108 comprises the following components: HTML and Javascript code to implement the design and the user interface, a static embedded Javascript file (located on a source servers) containing the codebase for supporting the player control API, and a dynamically-generated Javascript file (located on distributor servers) which contains variable definitions relevant to the current user session.

Client 108 will typically be encountered by a user as a link on a distributor web page. That link will pop up a new HTML window and load client 108 into that window. This HTML page will reside on a distributor's website, but will include two Javascript SCRIPT tags which reference files on a source server. (This is not required and the source could also reside on the distributor's server.) The first link is a static link to the codebase for supporting the player control API, in the following format: http://coreStreamRoot/Client108API.js. The second SRC link is to management sever 110 (in particular, the playlist generator 115 component thereof) and passes the Ruleset ID for playback as part of the request, in the following format: http://coreStreamRoot/server110.jsp?rs=wxyz (where wxyz is replaced with a randomly generated string which uniquely identifies the Ruleset).

In response, the playlist generator 115 looks for the presence of a cookie in the HTTP request identifying the user as a previously-recorded user of client 108. If no cookie is provided, server 110 returns information that causes client 108 to load the user preferences form.

Once preferences and demographic information is available, the player will load. During load, the player dynamically creates an <EMBED> object for the selected media player using Javascript document.write commands. The source parameter of the embedded player contains a link to playlist generator 115. Depending on the desired format, this request will have one of the following formats:

http://coreStreamRoot/playlist.asx?usr=USR&rnd=RND&rs=wxyz,

http://coreStreamRoot/playlist.smil?usr=USR&rnd=RND&rs=wxyz,

http://coreStreamRoot/playlist.xml?usr=USR&rnd=RND&rs=wxyz.

In both cases, wxyz is replaced with the Ruleset identifier string, USR is replaced by a UserID supplied by server 110, and RND is replaced by a system generated number (e.g., psuedo random, etc.) also provided by server 110. In most cases, loading and playback of the dynamically-generated playlist will commence immediately. During playback, client 108 monitors playback status every second. When events or state changes occur, and also every ten seconds during playback, client 108 transmits reporting data back to reporting server 130 (e.g., collector component 133).

There are a number of failure cases which client 108 attempts to recognize and workaround. Upon recognizing any of the below failure cases, client 108 makes a new request from playlist generator 115 with the provider selection parameter incremented. It then attempts to load the clip referenced in the new playlist, forwards to the point in the timeline at which the failure occurred, and resumes playback.

A Bad URL. In this failure case, the URL to a media file supplied by playlist generator 115 fails to resolve to a valid media file hosted on a working server. This is a very common failure case and may happen for any number of reasons, including a failure to distribute the media file properly, a failure in round-robin server pool management, or simple data entry errors. In both Real and Windows players, this failure case is recognized very quickly because playstate changes from “PREPARING” to “STOPPED” or “UNKNOWN”.

A Buffer Stall. In this failure case, the URL resolves correctly but the available bandwidth from the server is not sufficient to buffer correctly. Currently, client 108 simply has a constant time limit for buffering (20 seconds); if buffering time exceeds this threshold, the Buffer Stall event is declared. Client 108 can alternatively detect this failure case by monitoring the BufferingProgress property of the Windows Media player or the BufferingTimeElapsed and BufferingTimeRemaining properties of the Real player.

A Playback Stall. In this failure case, playback actually commences, but at some point during playback, the dataflow from the server fails.

An Unacceptable Packet Loss. In this failure case, the packet loss in the last ten second interval exceeds a preset threshold (currently set at 20 packets). This information is available from the GetPacketsMissing method of the Real player and the LostPackets property of the Windows Media player. One may wish to consider revising this test to examine loss as a percentage of total packets transferred rather than a constant value.

A Failure Response. In the event of a failure, client 108 requests a new playlist from server 110, employing a different provider for the clip that has failed. The format for that request described in the “SMIL/ASX Playlist Generator” section, below.

Management Server 110

When a user launches client 108 for the first time on a particular distributor's content, they are presented with a form soliciting both user preferences (preferred player and bandwidth), and any number of customer supplied demographic questions. User preferences questions are assumed to be the same across all customers, and are predefined. Demographic questions, on the other hand, can be determined by providers, and are grouped together into demographic sets, which are then assigned to RuleSets. A demographic question set comprises any number of questions. Each question is comprised of the question text, an optional description, an answer data-type, some type specific data, and an answer required/optional flag. Possible data types are: integer, type in string, multiple choice, combo multiple choice/string, or true/false. Integer types also have a minimum and maximum value, and string or combo types have a maximum string length.

When client 108 is invoked, it looks to see if it needs to redirect to the preferences form. This decision is made by server 110, and reported to client 108 by the playlist generator 115. If required, client 108 will redirect to form generator 116 of server 110, including the RuleSet ID from the original customer link, by changing the browser location to http://coreStreamRoot/prefsForm.jsp?rs=wxyz (where wxyz is the RuleSet identifier string). Server 110 looks up the demographic questions and synthesizes the HTML form. Each input element's name will be f1234, where 1234 is replaced with the DemographicItemID of that field from the database. There are also hidden fields for the RuleSet identifier string and user ID.

When the user submits the form, management server 100 performs error checking. Possible errors include omission of a required field, string too long or too short, or integer out of bounds. In the event of an error, the preferences form will be redisplayed along with an appropriate error message. Otherwise, the user's responses will be recorded in the database (either by inserting them or updating previously given responses). After the database has been updated, the browser window will be redirected back to the original content page, which will now run client 108.

The content page first invokes server 110 with a <script src=“URL”> tag. The URL which invokes server 110 looks like http://coreStreamRoot/server110JS.jsp?rs=wxyz (where wxyz is the RuleSet identifier string). Server 110 first checks that the supplied RuleSet ID is valid, and returns an error if necessary (further described below). Server 110 then tests to see if the preferences form needs to be displayed, and returns an indicator if so. Server 110 selects a system generated number (e.g., a psuedo random number), and then processes the RuleSet, generating a list of MediaBalls. Server 110 then selects a media format. First it checks if all MediaBalls on the list are available in the user's preferred format; if so, that format is used. Otherwise, all formats that the user supports are tested in a predefined (server-side) order; the first one which can run all of the MediaBalls is used. If no suitable format can be selected, an error is reported. If everything is successful at this point, server 110 returns the user ID, the selected seed, the selected format, the number of MediaBalls in the playlist, and a list of provider counts for each MediaBall to server 110.

As noted above, system 10 supports the concept of playlists, which are one or more mediaballs played in sequence. Creation of these playlists is done by playlist generator 115, by evaluating rulesets. Rulesets are comprised of one or more rules, which are filter expression defined with XML. It is possible to define rules which select mediaballs based on time (this is crucial for handling live events) or simple tests of user demographic data. There are also boolean joining operators (and, or, not, etc.) which can be used to combine several filter expressions into one. There is also a switch/case type structure which can be represented in the rulesets. These rules will be compiled from XML into Java classes, each of which has a method to create a playlist. Which compiled ruleset will be used is determined by the ruleset ID which the customer embeds in their HTML page. Before invoking the ruleset, the requesting user's demographic data collected to be used as input by the ruleset evaluation function.

Playlist generator 115 is also responsible for selecting file format based on preferences and available media, and all clips in the playlist must be available in the chosen format.

When the client 108 requests a playlist from playlist generator 115, a ruleset is evaluated. The result is cached and a cache ID is returned to client 108, which is used to fetch SMIL or ASX files. In addition, playlist generator 115 returns a list of provider IDs for each clip in the playlist. Client 108 uses this list to do intelligent fail over, or fallback.

In the case where server 110 decides that the user should be presented with the preferences form, the returned script will consist of:

var redirectUrl=“http://coreStreamRoot/prefsForm.jsp?rs=1234”;

Error

When server 110 has an error condition to report, the returned script will consist of:

var error=“Error text”;

Success

When everything is successful, the script returned by server 110 will be:

var playlist={userID:1234, randomSeed:2345, mediaBallCount:3, providerCounts:[2, 4, 3], playlistURL:“playlist.asx”}.

When client 108 causes the media player component to start playing, it does so by pointing the player at the URL of the SMIL/ASX generator, with the cache ID. The SMIL/ASX generator will produce a playlist containing the mediaballs chosen by playlist generator. Should playback of a clip in the playlist fail, client 108 will tell the player to re-request the playlist from the SMIL/ASX generator, but the URL will now indicate which provider failed, and the generator will remove that provider from the playlist and regenerate the SMIL/ASX file.

The SMIL/ASX playlist generator is responsible for generating a playlist for the underlying streaming media client being used by client 108. It is provided with much of the information obtained from the player data generator. There are actually two calling points for the playlist generator, one ending in .ASX and the other in .SMIL, producing either a SMIL file or an ASX file, as appropriate for the player. In the event of a failure, client 108 requests a new SMIL or ASX file, including information about which clip and host failed.

In order to produce a playlist which consistently contains the same MediaBalls in a stateless environment, the SMIL/ASX generator needs the following data: user ID, random seed, and RuleSet ID. (The format ID is uniquely determined by the version of the playlist generator that was called—either playlist.asx or playlist.smil.) In addition, if the list is being requested due to a failure, the generator needs to know which clip and provider failed. The URL which the streaming client is told to load is “http://coreStreamRoot/playlistURL?usr=USR&rnd=RND&rs=wxyz”, where playlistURL is the generator URL returned in the playlist object, USR is the userID, RND is replaced by a system generated number (e.g., pseudo-random), and wxyz is the RuleSet identifier string. If this is a list re-request caused by a failure, this URL also has “&clip=CLIP&host=HOST” appended to it, where CLIP is the clip number (starting from 0), and HOST is the host number (starting from 0). This alternate host only affects the specified clip—all others will still use host 0.

The following is an illustrative SMIL format:

<smil>
<head>
<meta name=“title” content=“Corestream Demo”/>
<layout>

<root-layout width=“320” height=“240” background-

color=“black”/>

<region id=“video” left=“0” top=“0” width=“320”

height=“240” z-index=“0”/>
</layout>
<body>

<seq>

<video

src=“rtsp://streamingserverRoot/customerid_customer/clipid1.rm
” region=“video”>

<video

src=“rtsp://streamingserverRoot/customerid_customer/clipi
d2.rm” region=“video”>
</seq>

</body>
</smil>.

The following is an illustrative ASX format:

<ASX VERSION=“3”>

<ENTRY>

<REF

HREF=mms://streamingserverRoot/customerid_customer/cli
pid1.asf>

<REF

HREF=mms://streamingserverRoot/customerid_customer/cli
pid2.asf>

</ENTRY>

</ASX>.

The Provider selection heuristic. Internally, the provider module will be a separate object which will return a Vector of Host objects—each Host object will have the same information as the Host record in the database.

Reporting Server 130

The reporting system of reporting server 130 is responsible for collecting and processing event data from all of the active clients (e.g., clients 108 on various user machines)in various locations on the Internet, and providing both real-time and historical reporting capabilities. There are 3 main components to this system; data collection, real time reporting, and historical reporting.

The primary job of the data collector(s) (as represented by collector 133) is to establish and maintain reporting context sessions, and distill the large amount of data coming back from clients 108 (which is mostly heartbeat events) into more interesting information. The collectors are also responsible for timing out sessions when clients 108 simply stop sending back data without explicitly shutting down. The event stream from a collector 133 is then both relayed to the real-time reporting engine 134—which must be able to correlate data from all clients simultaneously—and inserted into database 190. Note that the collectors are stateful—once a reporting session is established between an instance of client 108 and a collector 133, all events from that client must go to the same collector. If a collector dies, however, the only thing lost is the ability to report about the sessions it was maintaining at the time it died—Client 108 playback will not be affected, and nor will other collectors.

In addition to the collectors, there is a single reporting engine (134 and 135) server which collates information for real time customer reporting and real-time error detection. The collectors will summarize event data for the reporting engine, which will do user database lookups and collate usage patterns and viewer demographics in various ways.

In view of the above, client 108 reports a number of conditions to reporting server 130 via HTTP requests. The reporting server 130 is responsible for processing these requests, establishing server side sessions summarizing reported data for insertion into the database, timing out dead sessions, and updating the real time reporting server. This server will have to handle a high volume of requests, and, preferably, should be built in C++ as an apache module, although this is not required for the inventive concept.

The information stored in the database will include viewing session start and end records for each user, clip viewing records for each clip viewed (if playback of a clip fails, and client 108 fallsback, then multiple clip viewed records will be generated for the same clip), as well as records for various user actions such as pause, resume, stop, etc.

The real time reporting applet 132 allows a customer to see information about the serving of their content at that moment. This information includes numbers of users, bandwidth and demographic summaries, etc. This information is presented by a Java applet, and updates dynamically every few seconds.

The real time reporting applet must continually poll for updates to the data (as well as loading the data in the first place). This data is supplied by the real time reporting server. This server gets summary data from the collectors 133, and to some extent duplicates the work that they do. Each time a collector starts or ends a user session, the reporting server does as well, as it needs to fetch user demographic data from the database.

The historical reporting server is a web application, 131, which allows customers to examine past traffic patterns for their content, as well as view demographic information for the users who have viewed that content. Illustratively, this report can use an appropriate plug-in to produce an Excel spreadsheet with this data.

Client 108 collects information on user preferences, user actions, provider performance, and self-triggered events (such as fallback to a backup provider in the event of transmission errors). This information is transmitted back to reporting server 130 using Javascript-generated calls to a dummy image.

Each message consists of a message type plus parameters specific to that message. All of this information is expressed as standard GET data on the end of the image URL, with the message type listed as the “msg” parameter, and the other parameters following. Here is an example of a reporting server 130 URL request:

http://server130.interocity.com/blank.gif?msg=BUFFERSTART&medi aID=374&provID=17&formatID=1.

Messages fall into two main categories: events and periodic status messages.

There are a number of tables involved in the representation of the data reported back by a client 108; these are ViewSession, ClipSession, and ClipEvent. Reporting server 130 inserts one record into ViewSession for each separate user viewing session—a viewing session exists from the time a user first starts viewing the first (or only) clip in a playlist, and lasts until client 108 is closed, or the session times out. The ViewSession record contains information about the user—their user ID, the RuleSet they are viewing, their IP address, browser information (there is an ancillary table which stores information about all streaming media clients installed on their system at the time they begin a viewing session), etc. There are any number of ClipSession records associated with a viewing session. A clip session represents the user watching a particular MediaFile served by a particular host. New ClipSession records are created whenever the user begins a new clip, or any time client 108 decides to switch hosts. ClipSession records describe the clip being played and the host which is serving it. Any number of ClipEvent records can be associated with a clip session as well. A ClipEvent record can describe any event returned by client 108 as per the messaging described above (except PlayContinue), or session timeout events.

The real-time reporting engine (134 and 135) are also responsible for detecting two classes of errors: high failure rates associated with specific hosts, and high failure rates associated with specific MediaBalls.

In both cases, this detection is done the same way. The real-time reporting engine will maintain two Hashtables; one will have an element for each host, the other will have an element for each MediaBall. Each element has a small array of success and failure counts—these elements have 1 element for each hour of history that they cover. Once an hour, the oldest array element will be discarded, all remaining elements will roll over, and a new element will be added to the head.

Each time a ClipSession completes without a failure, the relevant MediaBall's record is updated, increasing the success count in the head location of the array. In addition, the host that it was served from also has the success recorded in its record. Failures are recorded in just the same way.

If (successes+failures)>sample size threshold and failures/successes>failure threshold, then an error has been detected and must be dealt with by the system.

At present, dealing with these errors will be handled simply by sending out an email to one or more addresses. In the future, automated remedial action may be taken through integration with the playlist generator.

Real-time reporting is handled by two separate systems; a server-side reporting engine, and a client side data rendering applet. The server-side system is primarily interested in maintaining a view of the currently active set of users, their demographic information, and what they are viewing, as well as a view of the currently active hosts, along with any exceptional conditions that may be being reported about them. The rendering applet connects to the reporting engine, establishes and alters filters which describe what the customer wants to see, and is fed updates at regular intervals.

The real-time report front-end. Select MediaBall or RuleSet. This tool allows the customer to select from among his currently-live MediaBalls or Rulesets. Choosing an item will launch the Real-time Report window for that item.

Real-time Report Window. The Real-Time report window will provide a graphical and textual display of cumulative data on current viewers of the selected MediaBall or Ruleset. The display will include the following specific data in all cases:

Total number of current viewers,

Percent of current viewers who are new,

Average length of time viewed,

Average bandwidth used,

% breakdown of delivery format, without detailed version info (Real vs. Windows, etc.),

% breakdown of browser type, without detailed version info,

% breakdown of computer platform.

In addition to the standard dataset, the display will also show aggregate demographic information for each item in the Demographic Set assigned to the selected MediaBall or RuleSet. The specific format for displaying the data for each item will depend upon the field type of the item, as defined below, though in some special cases a different format may be used.

String/freeform text. Responses to freeform text fields will not be displayed by the real-time reporting applet.

Lookup/string combination. Responses to lookup/string combination items may be displayed in one of two ways. If the number of lookup items is reasonable (smaller than 10? 15?) then the data will be displayed as a bar graph, with each item listed along the X-axis in the order they appear in the end-user's drop box. Non-lookup responses (if any) will be summed into a single “other” item which appears as the rightmost bar on the bar graph.

Integer. Responses to integer items are displayed as an average to two decimal points of precision.

Boolean. Responses to boolean items are displayed as a “horizontal pie” chart (as in the “Format Usage” and “Platform” items below).

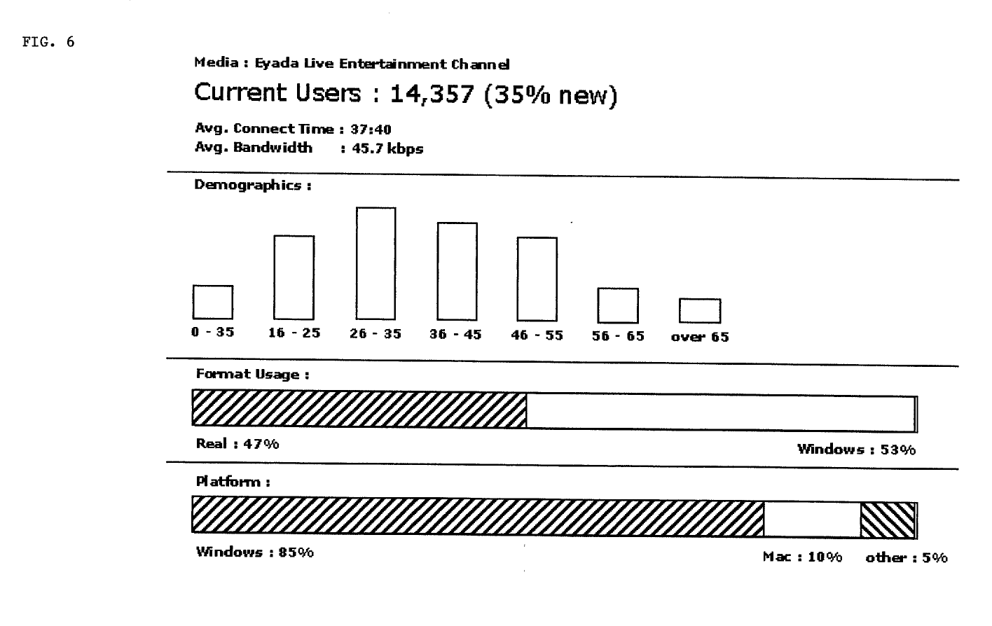

A sample report is shown in FIG. 6.

Asset Server 140

The illustrative system shown in FIG. 3 allows customers to pack multiple streaming media files which represent the same content into atomic “mediaballs”—these files can be encoded in different formats and/or at different sizes or bit rates, but the encoded content for all clips in a mediaball should be the same. In addition, there is metadata to be associated both with individual clip files (format, size, bit rate, color depth), and with the mediaball as a whole. Mediaball associated metadata identifies information about the clip, such as Title, Publisher, Description, etc. There is an organization called “The Dublin Core Metadata Initiative” (http://dublincore.org) which has defined a metadata standard which will be used for mediaball level metadata.

Asset server 140 is built around a media management server which encapsulates all of the business logic associated with managing media assets within the system and, e.g., interfacing with other similar systems. This system will expose an API (preferably using RMI (Remote Method Invocation), most likely) which will be used to build public media management interfaces—a web application will be developed initially, future planned asset management application include a full client side application and plug-ins for major third party asset management systems (Artesia and Virage are early planned targets).

This management system will allow the client (through any of the mechanisms described above) to transfer encoded media files to the file store, define metadata, (possibly) select hosts for the data, define playlist rules, and schedule content publication.

After the Customer has transferred content to using the asset management facilities and defined all associated data, they schedule this content for publication (possibly scheduling it for immediate publication). When it is time to publish the content, the distributor 195 will be invoked. Its function is to upload all of the content files associated with the mediaball being published to all of the hosting servers which will be serving them (e.g., 196). Upon successfully uploading the files, the database will be updated to reflect this. When the content files have been uploaded to all of their intended servers, the mediaball will be marked active.

Asset server (or system) 140 is broken down into a number of subsystems. The first of these is the core asset management server. This server handles all the backend details of asset management, and provides public interfaces (using Java RMI) for other asset management subsystems to use. Another illustrative form of asset subsystem is the web based asset management front end. This is a JSP based web application which acts as an RMI client of the core asset server.

Asset management front-end. Illustratively, distributors may be allowed to have access to all the major tables of the database by an HTML forms-based front-end tool.

Create/Update/Delete MediaBall. This tool will allow registered distributors to create or delete MediaBall objects, and to modify all metadata associated with a MediaBall. Upon creation of a new MediaBall, the user shall be forwarded to the Upload Mediafile tool, specified below, to associate Mediafiles with the MediaBall.

Create/Update/Delete/Upload MediaFiles. This tool will allow the distributor to upload or delete MediaFiles associated with an existing MediaBall, and to modify metadata associated with the MediaFiles. Such metadata shall include:

MediaFile format (Real/Windows)

Bandwidth supported (or multiple bandwidths supported, in the case of SureStream files or the like)

Pixel dimensions.

Future development may include the automatic detection of this metadata upon upload, but for now the user must enter this data manually. The upload tool shall include a means for monitoring upload progress and resuming uploads.

Deploy/Decommission MediaBall. This tool allows distributors to “Deploy” the MediaFiles associated with a MediaBall out to the appropriate content delivery networks, or to “Decommission” a previously-deployed MediaBall by deleting its MediaFiles from the relevant CDN's.

Create/Update/Delete RuleSets. This tool allows distributors to create, update, and delete the RuleSets which create playlists. The interface for this tool has yet to be determined, but it will shield users from the complexities of the XML RuleSet language.

Check MediaBall or Ruleset. This tool allows distributors to verify the completeness of RuleSets and the availability of the MediaFiles relevant to any selected MediaBall or RuleSet. It employs the Check functions of the High-Level Invoker portion of server 140 Distribution component.

Create/Update/Delete Live MediaFile (“MediaFeed”). This tool allows administrators to create, update and delete Live MediaFile records (“MediaFeeds”).

Create/Update/Delete Live Host. This tool allows administrators to create, update and delete Live Host records. These host setups typically will be reassigned to multiple MediaBalls during their lifetimes.

Create/Update/Delete MediaBall/MediaFeed override. This tool allows administrators to assign Live Hosts and MediaFile records to existing MediaBalls already created for or by Customers.

Create/Update/Delete Provider. This tool allows administrators to create, update and delete Provider records.

Create/Update/Delete Host. This tool allows administrators to create, update and delete Host records.

Create/Update/Delete Customer. This tool allows administrators to create, update and delete Customer records.

Create/Update/Delete Login. This tool allows administrators to create, update and delete Login records. Multiple login records can be created for each Customer.

File store. The file store holds a copy of every deployed media file.

Rule/Ruleset Specification

RuleSets are used to generate lists of one or more MediaBalls. Distributor pages always reference RuleSets—a page which only needs to display one MediaBall just has a very simple RuleSet. A RuleSet is a collection of one or more rules.

A rule is an XML fragment which tells the rule interpreting system whether or not a MediaBall should be played by the rule, and, if so, which one. The rule is basically a hierarchical collection of filter expressions and joining operators.

ENTITY expr “not|and|or|demographic|before after”. %expr entities are expressions which evaluate to either true or false: they are the basic building blocks of the rule tests. More will be said about the elements which are allowed in an expression when those elements are described, below.

ENTITY demographicExpr “lt|le|eq|ge|gt|ne |in|inrange|istrue|isfalse|isnull”. %demographicExpr entities are expressions which are used to test user demographics.

ELEMENT rule (if*, switch*). Rule is the root element.

ELEMENT if (test, #MEDIABALLID, else?). If the test evaluates true, then the rule evaluates to the specified MEDIABALLID. If the test evaluates false and an else element exists, that MEDIABALLID is used instead. MEDIABALLIDs are formatted as customer name|media ball name.

ELEMENT switch (case*, default?). The switch element is basically a convenient way to represent a number of if elements. The first case which evaluates true be used. If no cases evaluate true and a default is specified, that MEDIABALLID will be used.

ELEMENT test (.expr)*. The test element specifies the test expression for an if or case element.

ELEMENT else (#MEDIABALLID). The else element specifies the MEDIABALLID to use if the specified test evaluates false.

ELEMENT case (test, #MEDIABALLID). If the specified test evaluates true, then the rule will return MEDIABALLID.

ELEMENT default (#MEDIABALLID). If all cases in a switch are false, and a default is included, then the specified MEDIABALLID is returned by the rule.

ELEMENT not (.expr)*. The not element inverts the result of the enclosed expression.

ELEMENT and (.expr)*. The and element will evaluate true if all expressions contained within evaluate true, false otherwise.

ELEMENT or (.expr)*. The or element will evaluate true if any expressions contained within evaluate true, false otherwise.

ELEMENT demographic (item, %demographicExpr). The demographic element is used to specify demographic tests on a specified demographic item.

ELEMENT before (date, time). The before element will evaluate true if the current time (on the server) is earlier than the specified date and time.

ELEMENT after (date, time). The before element will evaluate true if the current time (on the server) is later than the specified date and time.

ELEMENT item (#ITEMNAME). The item element specifies the demographic item to test against—it is the text of a demographic question, which must be unique within a particular customer (a system exists to present the same question text to a user despite this requirement—see the demographics section).

ELEMENT lt (#INTEGER). The lt element evaluates true if the user's response (to an integer type question) is less than the specified value.

ELEMENT le (#INTEGER). The le element evaluates true if the user's response (to an integer type question) is less than or equal to the specified value.

ELEMENT eq (#INTEGER #VALUE). The eq element evaluates true if the user's response is equal to the specified value.

ELEMENT ge (#INTEGER). The ge element evaluates true if the user's response (to an integer type question) is greater than or equal to the specified value.

ELEMENT gt (#INTEGER). The gt element evaluates true if the user's response (to an integer type question) is greater than the specified value.

ELEMENT ne (#INTEGER #VALUE). The eq element evaluates true if the user's response is not equal to the specified value.

ELEMENT in (value+). The in element evaluates true if the user's response is equal to the any of specified values.

ELEMENT inrange (#INTEGER, #INTEGER). The inrange element evaluates true if the user's response (to an integer type question) is between the two specified value.

ELEMENT istrue EMPTY. The istrue element evaluates true if the user's response (to a Boolean type question) is true.

ELEMENT isfalse EMPTY. The isfalse element evaluates true if the user's response (to a Boolean type question) is false.

ELEMENT isnull EMPTY. The isnull element evaluates true if the user did not answer the question.

ELEMENT date (#DATESPEC). The date element is used to specify dates—DATESPEC is mm/dd/yyyy.

ELEMENT time (#TIMESPEC). The time element is used to specify times—TIMESPEC is hh:mm:ss (hh is 0-23).

ELEMENT value (#VALUE). The value element is used to specify a value.

XML examples

<rule>
<switch>

<case>

<test>

<and>

<demographic>

<item>Industry</item>
<eq>Computers and Internet</eq>

</demographic>
<demographic>

<item>Profession</item>

<in><value>engineer</value><value>designer</value></in >

</demographic>

</and>

</test>
chyron|corestream-ad-1

</case>
<case>

<test>

<demographic>

<item>Have children</item>
<istrue/>

</demographic>

</test>
fisher-price|barney-purple-ad-1

</case>
<default>Chyron | The COMPANY the WHOLE WORLD
WATCHES

```
</default>
  </switch>
  <if>
  </if>
</rule>
```

Demographic questions are grouped into demographic sets—the same question can exist in any number of demographic sets (but not across customers) and the order of the questions can be specified for each set.

Multiple choice/lookup. This item type can have any number of answers defined by the customer. Each possible answer includes the text of the answer, as well as optional integer range data, which is used for statistical analysis. For example, a demographic question which asks the user their age and provides a selection of age ranges to choose from can be annotated with integers holding the bounds of each range, to make data mining simpler. This item type can be rendered as either a drop-down <select> field, or as a collection of radio buttons [there is no provision for the customer to specify which way to do it]. If the item is not marked as required, then an additional answer of “No answer” will be added to the list.

String/freeform text. This item type simply allows the user to type in a response. Maximum response length is specified by the customer.

Lookup/string combination. This is a combination of the above two item types. In addition to the customer supplied answer possibilities, “Other (please specify)” is added, along with a string field to do so. Client side JavaScript is generated to ensure that either a choice is selected or an answer is typed in, but not both.

Integer. This item type allows the user to type in a number, the acceptable bounds of which are specified by the customer. Management server 1110 decides to render this as either a type in field (with client JavaScript validation), or as a drop-down field, if the range of possible values is small enough.

Boolean. This is either a check box or a drop-down if the item is not required (“Yes”, “No”, “No answer”).

Although the invention herein has been described with reference to particular embodiments, it is to be understood that these embodiments are merely illustrative of the principles and applications of the invention. It is therefore to be understood that numerous modifications may be made to the illustrative embodiments and that other arrangements may be devised without departing from the spirit and scope of the invention. For example, although the inventive concept was illustrated in the context of separate servers providing different functions, any combination of these functions, even all of these functions, can be provided on one server.

1. A method for use in playing content retrieved from a network, the method comprising the steps of:
retrieving a first media file, associated with the content, from the network;
playing the first media file;
automatically falling back to retrieve a second media file, associated with the content, from the network when a failure is detected in playing the first media file; and
playing the second media file.

2. The method of claim 1 wherein the first media file and the second media file are retrieved from a first location in the network and a second location in the network, respectively.

3. The method of claim 1 comprising the step of determining that the first media file is associated with a provider that is more optimum for retrieving content therefrom than a second provider associated with the second media file.

4. The method of claim 1 wherein the automatically falling back step comprises the step of requesting information from a server in the network, the information used for identifying an address for retrieving the second media file therefrom.

5. A method for use in playing content from a network, the method comprising the steps of:
providing a first media playlist to a client computer, the first media playlist comprising an address associated with a first media file associated with the content, which the client computer can use for playing the first media file;
subsequently receiving a request from the client computer for a second media playlist, the second media playlist comprising an address associated with a second media file associated with the content, which the client computer may use for playing the second media file if a failure occurs in playing the first media file; and
providing the second media playlist to the client computer.

6. The method of claim 5 wherein the subsequently received request from the client computer comprises failure information associated with the playing of the first media file.

7. The method of claim 5 wherein the address is a uniform resource locator (URL).

8. The method of claim 5 wherein the first media playlist references not only the first media file address but also the second media file address, and wherein the second media playlist only reference the second media file address.

9. The method of claim 5 wherein each media play list references at least one media group, each media group comprising a media ball, which comprises at least one media file and an associated location for the at least one media file.

10. The method of claim 9 wherein each media group has associated therewith a group metadata set describing a media selection associated with the media group, wherein each group metadata set comprises at least one of a value identifying a title of the media selection, a value identifying a publisher of the media selection, and a value identifying content of the media selection.

11. The method of claim 5 wherein the step of providing the first media playlist includes the steps of:
retrieving selection criteria associated with different providers of the content;
selecting a provider for providing the first media file;
forming the first media playlist comprising the address of the selected provider.

12. The method of claim 11 wherein the selection criteria comprises at least one of a rule set, player preference data and demographic data associated with a user of the client computer.

13. The method of claim 12 further comprising the steps of soliciting and receiving from the user, and storing in a storage medium in a manner associated with the user, at least one of the player preference data and the user demographic data.

14. The method of claim 13 further comprising the step of associating a user identifier with the stored user data.

15. The method of claim 13 wherein the storage medium is a cookie on the client computer.

16. The method of claim 13 wherein the preference data comprises at least one of a connection speed, a media player type, and a media file format.

17. The method of claim 5 further comprising the step of receiving performance data from the client computer associated with the playing of the content.

18. The method of claim 17 wherein the performance data comprises at least one of session start time, session end time, failure information, latency information, clip viewed information, and transport activity.

19. The method of claim 17 further comprising the steps of processing the performance data for real-time reporting and providing the processed performance data to a real-time report viewer adapted to request and receive the processed performance data.

20. The method of claim 17 further comprising the steps of processing the performance data for historical reporting and providing the processed performance data to a historical report viewer adapted to request and receive the processed performance data.

21. The method of claim 5 further comprising the steps of:
receiving, from the network, media groups, each media group comprising a media ball, which comprises at least one media file and an associated location for the at least one media file; and
storing each media group for use in playing the content.

22. A computer program product comprising a computer readable medium having computer program code, for executing a streaming media player, the product comprising:
code for retrieving a first media file, associated with content, from a network;
code for playing the first media file; and
code for automatically falling back to retrieve, for playing, a second media file, associated with the content, from the network when a failure is detected in playing the first media file.

23. The computer program product of claim 22 wherein the first media file and the second media file are retrieved from a first location in the network and a second location in the network, respectively.

24. The computer program product of claim 22 further comprising code for determining that the first media file is associated with a provider that is more optimum for retrieving content therefrom than a second provider associated with the second media file.

25. The computer program product of claim 22 wherein the code for automatically falling back further includes code for requesting information from a server in the network, the information used for identifying an address for retrieving the second media file therefrom.

26. A computer program product comprising a computer readable medium having computer program code, for use in playing content from a network, the product comprising:
code for providing a first media playlist to a client computer, the first media playlist comprising an address associated with a first media file associated with the content, which the client computer can use for playing the first media file; and
code for subsequently providing a second media playlist to the client computer, the second media playlist comprising an address associated with a second media file associated with the content, which the client computer may use for playing the second media file if a failure occurs in playing the first media file.

27. A server for use in playing content from a network, the server comprising:
at least one processor for executing a program; and
memory for storing the program;
wherein the program causes the server to (a) provide a first media playlist to a client computer, the first media playlist comprising an address associated with a first media file associated with the content, which the client computer can use for playing the first media file; and (b) to provide a second media playlist comprising an address associated with a second media file associated with the content, which the client computer may use for playing the second media file if a failure occurs in playing the first media file.

28. Apparatus for use in playing content from a network, the apparatus comprising:
means for determining a first provider of the content and a second provider of the content; and
means for (a) providing a first media playlist to a client computer, the first media playlist comprising an address associated with a first media file associated with the first provider, which the client computer can use for playing the first media file; and (b) subsequently providing a second media playlist to the client computer, the second media playlist comprising an address associated with a second media file associated with the second provider, which the client computer may use for playing the second media file if a failure occurs in playing the first media file.

29. The apparatus of claim 28 wherein the subsequently received request from the client computer comprises failure information associated with the playing of the first media file.

30. The apparatus of claim 28 wherein the address is a uniform resource locator (URL).

31. The apparatus of claim 28 wherein the first media playlist references not only the first media file address but also the second media file address, and wherein the second media playlist only reference the second media file address.

32. The apparatus of claim 28 wherein each media play list references at least one media group, each media group comprising a media ball, which comprises at least one media file and an associated location for the at least one media file.

33. The apparatus of claim 32 wherein each media group has associated therewith a group metadata set describing a media selection associated with the media group, wherein each group metadata set comprises at least one of a value identifying a title of the media selection, a value identifying a publisher of the media selection, and a value identifying content of the media selection.

34. The apparatus of claim 28 wherein means for determining retrieves selection criteria associated with different providers of the content.

35. The apparatus of claim 34 wherein the selection criteria comprises at least one of a rule set, player preference data and demographic data associated with a user of the client computer.

36. The apparatus of claim 35 wherein the preference data comprises at least one of a connection speed, a media player type, and a media file format.

37. The apparatus of claim 28 further comprising means for receiving performance data from the client computer associated with the playing of the content.

38. The apparatus of claim 37 wherein the performance data comprises at least one of session start time, session end time, failure information, latency information, clip viewed information, and transport activity.

39. The apparatus of claim 38 further comprising means for processing the performance data for real-time reporting and means for providing the processed performance data to a real-time report viewer adapted to request and receive the processed performance data.

40. The apparatus of claim 38 for comprising means for processing the performance data for historical reporting and means for providing the processed performance data to a historical report viewer adapted to request and receive the processed performance data.

41. The apparatus of claim 28 further comprising means for receiving, from the network, media groups, each media group comprising a media ball, which comprises at least one media file and an associated location for the at least one media file; and means for storing each media group for use in playing the content.
